(19) United States
(12) Patent Application Publication
(10) Pub. No.: US 2023/0391499 A1
(43) Pub. Date: Dec. 7, 2023

(54) Reusable Pallet Tent

(71) Applicant: Michael Roodenburg, Rotterdam (NL)

(72) Inventor: Michael Roodenburg, Rotterdam (NL)

(21) Appl. No.: 18/199,376

(22) Filed: May 19, 2023

(30) Foreign Application Priority Data
Jun. 1, 2022 (NL) 1044346

(51) Int. Cl. B65D 19/38

(52) U.S. Cl. CPC B65D 19/38; B65D 2519/00174; B65D 2519/00537; B65D 2519/0086; B65D 2519/00865

(57) ABSTRACT

The present invention discloses a novel form of a reusable pallet tent that is used to transport goods, like (small) boxes, on different types of pallets, is portable and foldable and can be used on if types of pallets. The tent is waterproof, has a UV-resistant coating and with scratch-resistant material it is durable and long lasting The said pallet tent has only one opening on the side, which is closed with two zippers from bottom to top. For use, the tent is placed on a pallet and before the goods are stacked inside the tent. When solidity for the small goods is needed, the zippers are raised a little by little to close the tent completely. The said tent is beneficial in that it is reusable and foldable so that it can be piled up for transportation. The material used in making the said tent re solid to ensure that the tent is durable and long lasting. Further, the invention is friendly to environment in that the tent is designed to transport higher volumes of goods at the same time inside a truck. This lowers CO2 emissions as well as lower use of plastic foil to seal a pallet and lower use of cardboard boxes that need to be recycled.

### FIELD OF THE INVENTION

The present invention relates to tents, and more particularly, to a reusable pallet tent that is foldable and used to transport goods such as boxes and reduce usable of plastics and cardboard boxes.

### DESCRIPTION OF TO RELATED ART

The present technologies to transport (small) goods on pallets, in my consciousness, are plastic sealing foil, cardboard boxes, plastic boxes and metal boxes.

Many types of goods used in manufacturing operations, such as sheet metal, are typically transported on a rectangular pallet. The rectangular pallet includes an upper planar surface which supports the goods which are piled on top of the pallet.

In order to retain the goods to the pallet during shipping typically crisscrossing steel bands extend across both the top of the goods as well as around the pallet. When use of the goods is desired at the manufacturing facility, the metal bands are typically cut from the pallet thus exposing the goods. In some cases, after the goods are used, the pallet is discarded.

There are several disadvantages to the previously known use of pallets for shipping goods to manufacturing facilities. One primary disadvantage is that the steel bands which retain the goods to the pallet, after removal from the pallet, are simply discarded. This is not only disadvantageously wasteful, but also creates a disposal problem for the steel bands. Furthermore, the steel bands are sharp, particularly at the point that they are cut from the pallet, and pose a potential safety hazard.

Furthermore, there are more options for sale transportation of pallets. For instance, a Plastic sealing foil: very bad for environment, and can be used only one time. Even the improved bio plastic foil can be used only one time. Also, to create this bin plastic tons of food (like maize) and water will be wasted.

Another method is use of cardboard boxes which is most of the time, can be used one time only. Cardboard need to be recycled and can only be recycled a limited number of times.

Plastic boxes is another traditional method which includes two kinds, foldable and non-foldable. They are both strong and reusable. However, transportation of a lower volume of goods, compared to the reusable tent is also questionable. Also, to transport these plastic boxes you need more space in a truck, even the foldable plastic box takes more space in a truck. This means they have more CO2 emissions.

The metal boxes are strong and reusable. The disadvantages are they can transport a lower volume of goods, compared to the reusable tent. Also, to transport these metal boxes you need more space in a truck, even if it would be a foldable box. This means they have more CO2 emissions.

Pallets are flat structures for carrying goods to form a unit load of the goods. The goods forming the load may be, for example, foodstuffs or other products. Pallets are typically made of wood. They include a deck (usually square or near-square) on which a load is placed. The deck is supported by an arrangement that allows forks of a forklift or pallet jack to lift and transport it. The pallets including their load can be transported on to and off from lorries, which carry unit loads on them long distances. Many standard configurations of pallet are used such as international or of standardization (ISO) pallets and Euro (CEN) pallets. These typically have dimensions of between 800 mm to 1200 mm by between 800 mm to 1200 mm.

By looking at prior art multiple patents have been seen in similar regards, For instance a Korean patent number KR200454669Y1 of 2004 discloses a reusable pallet cover, comprising a bag or box packaging, and the cover body of the elastic material formed in the form of a tube to wrap and package the pallet cargo stacked and stacked in multiple stages on the pallet, and the cover A portion of the lower circumference of the body has a plurality of downwardly protruding extension at a predetermined interval, consisting of a strap having a coupling hole formed in each protruding end, by extending the respective straps to bind the strap to the pallet using the coupling hole The packaged pallet cargo is supported by the pallet, so that the pallet can be more easily packed and supported by the pallet, and the palletized pallet can be easily transported by using a forklift to reduce the loading cost. By shortening the time, not only work efficiency but also in particular, the present invention relates to a reusable pallet cover that allows a pallet cover that has been used once to be reused. However, this prior art different from what is being proposed in the present invention.

The US patent number US20200283209A1 of 2002 describes a transportation base load unitizer. The transportation base load unitizer is used for unitizing a load on a transportation base, such as a pallet. The unitizer comprises at least one elastic section and at least one protection section for providing greater protection to a load on a transportation base than the at least one elastic section. The unitizer is configured such that, in use, the unitize holds together as a unit and protects a load on a transportation base. But is not a tent.

A U.S. Pat. No. 6,216,607B1 on reusable pallet for goods having a generally rectangular base with first and second spaced apart sides and an upper surface for supporting the goods. A winch having a rotatable drum is mounted adjacent the first side of the base while a ratchet and pawl are provided with the winch for selectively locking the drum against rotation. A retaining pin is secured to the second or opposite side of the base and in alignment with the winch. An elongated and flexible strap has one end wound around the winch drum while a hook attached to the other end of the strap is selectively attachable to the retaining pin. An actuating rod is connected to the pin for selectively moving the pin between a first position in which the hook engages the retaining pin, and a second position in which the retaining pin is moved out of engagement with the hook thereby releasing the strap.

A WO patent 2,010,100580A1 on Modular reusable pallet relates to a modular reusable pallet that has a small height (h) for transport and a large height (H) for storage. The modular reusable pallet can be operated both manually and by means of devices on a forklift or other transferring apparatuses. In the end positions, the set height (h, H) is secured using a positive interlocking so that an adjustment is not possible without active use of corresponding devices.

There are multiple solutions that have been presented in prior art regarding bringing advancements in various types of pallet tents and their functionality. However, these solutions are limited and restricted to their conventional systems. Moreover, by looking at prior art it is evident that a lot of labor and inconvenience would be obviated if sonic satisfactory means could not be employed for covering the pallets.

However, the current invention is focused on presenting an ergonomic a reusable pallet tent that is foldable and used to transport goods such as boxes and reduce usable of plastics and cardboard boxes. The problem it solves is transporting companies have a better option to transport (small) goods. The reusable tent is durable and can be used many times. Also, for the environment it is a better option, because with this tent a truck can be transporting a higher volume of goods at the same time. This means lower CO2 emissions. Compared to existing technologies, more goods can be transported at the same time and because it is reusable and foldable it has lower CO2 emissions.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of reusable pallet tent that is used to transport goods, like (small) boxes, on different types of pallets.

The primary objective of this invention is to provide an assembly where the said pallet tent has only one opening on the side, which is closed with two zippers from bottom to top.

It is another objective of the invention to provide novel form of arrangement which is reusable and foldable so that it can be piled up for transportation.

It is also the objective of invention to provide tent which is used to transport goods, like boxes, on different types of pallets and because the tent is made from a solid material, it is reusable and can be used for a long time.

It is also the objective of invention to provide solution in form of tents which is portable and foldable so they can be piled up for transportation.

It is further the objective of the invention to provide used in making the said tent are solid to ensure that the tent is durable and long lasting

It is also the objective of invention to provide space between the cushion offer air circulation for improved comfort.

It is further the objective of the invention to provide high quality material which is solid to ensure that the tent is durable and long lasting and maintains its effectiveness over longer period of time.

A still further object is to provide a reusable pallet tent that is economical in cost to manufacture.

It is a further object of the present invention to provide a new and improved form of reusable assembly which is of a durable and reliable construction.

Still yet another object of the present invention is to provide a new and improved reusable pallet tent which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is view of holders involved in the assembly as per preferred embodiments of the invention.

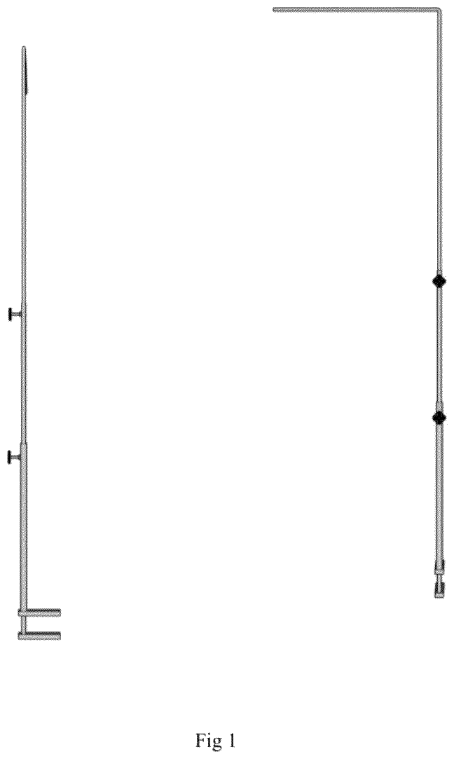

FIG. 2 is another view of holders involved in the assembly as per preferred embodiments of the invention.

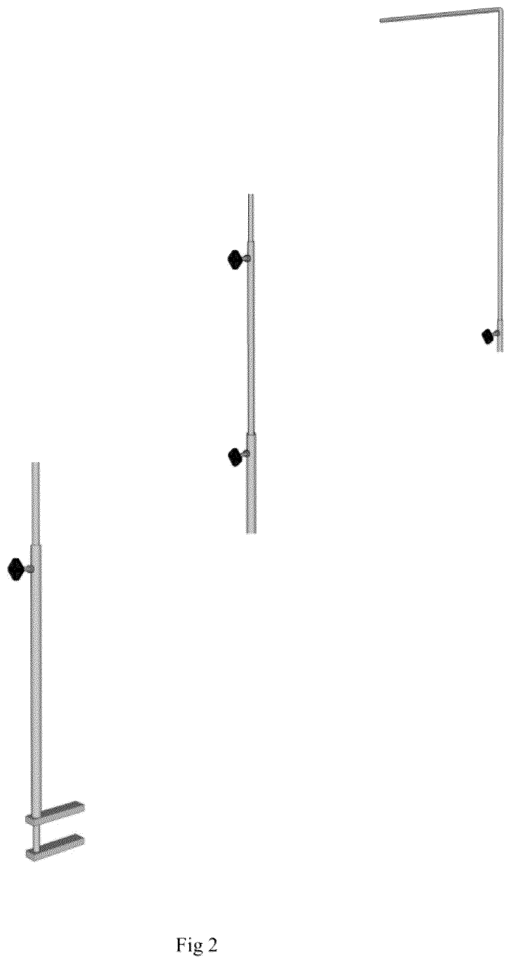

FIG. 3 shows detailed configuration of holders as preferred embodiments of the invention.

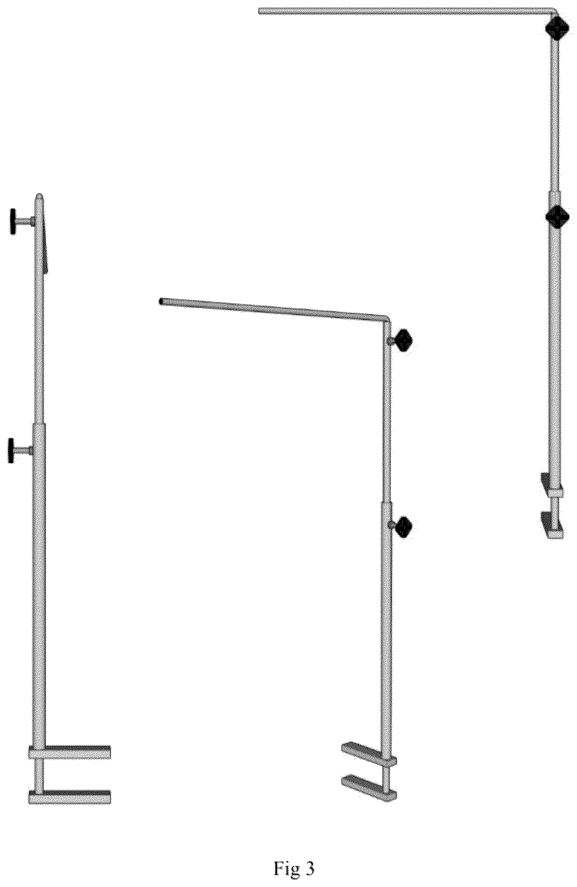

FIG. 4 shows bottom view of double Velcro involved in the assembly as per preferred embodiments of the invention.

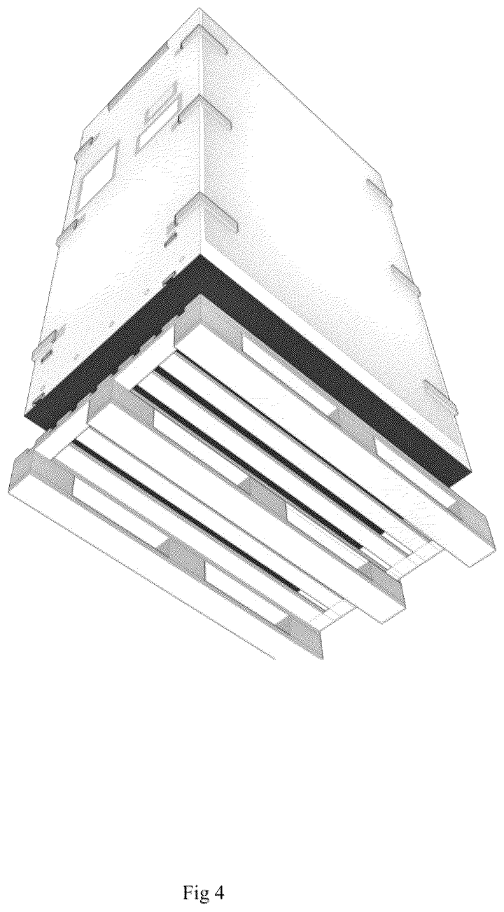

FIG. 5 shows front view of double Velcro involved in the assembly as per referred embodiments of the invention.

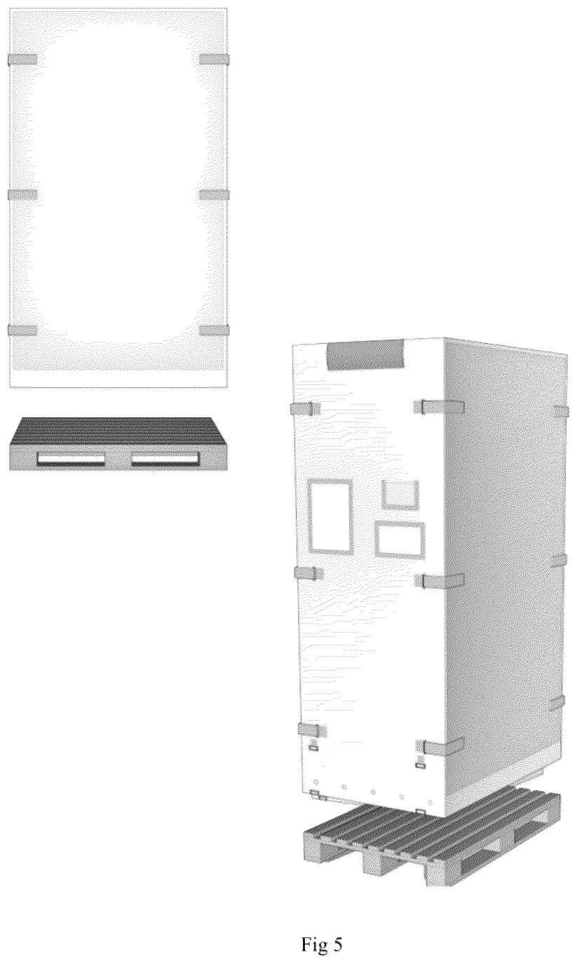

FIG. 6 shows side view of double Velcro involved in the assembly per preferred embodiments of the invention.

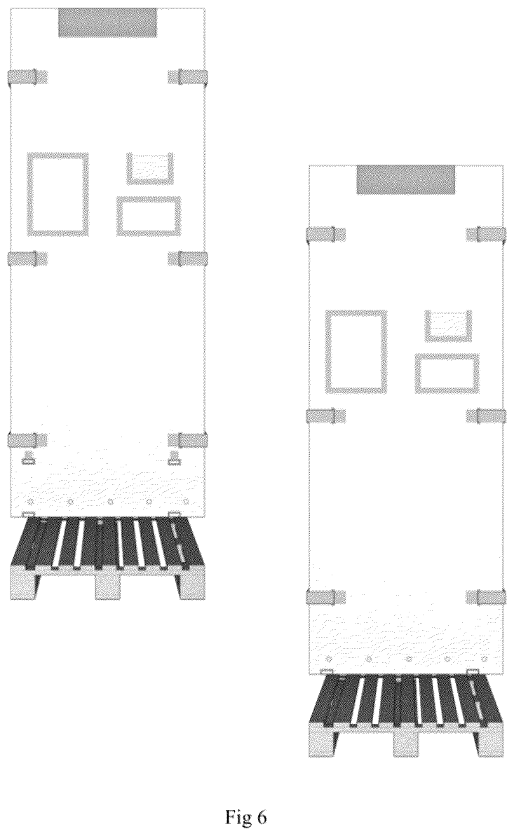

FIG. 7 shows bottom view of single Velcro involved in the assembly as per preferred embodiments of the invention.

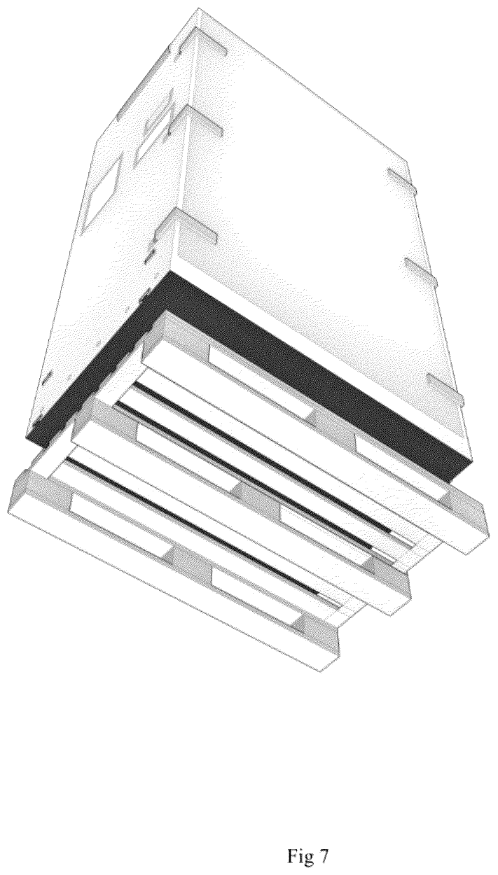

FIG. 8 shows front view of single Velcro involved in the assembly as per preferred embodiments of the invention.

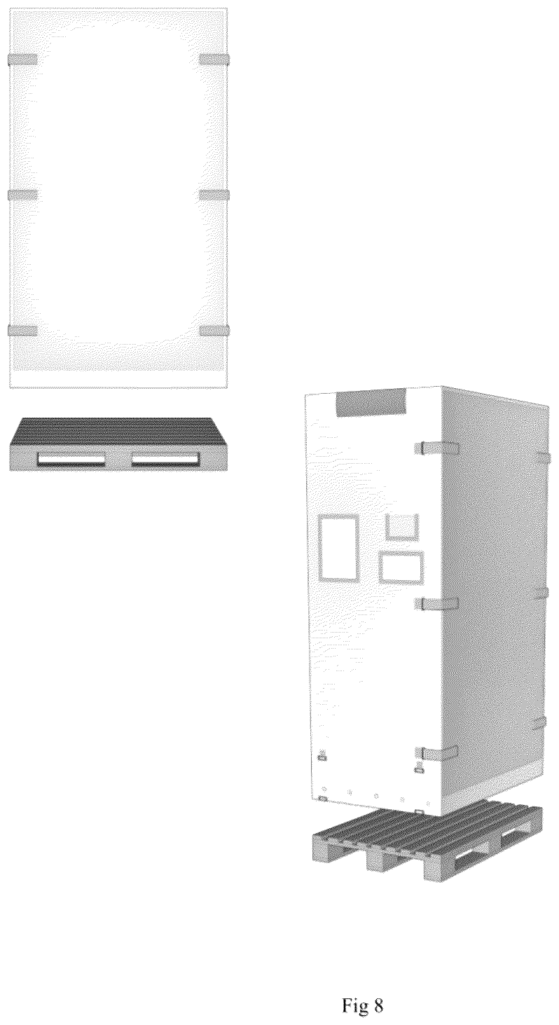

FIG. 9 shows side view of single Velcro involved in the assembly as per preferred embodiments of the invention.

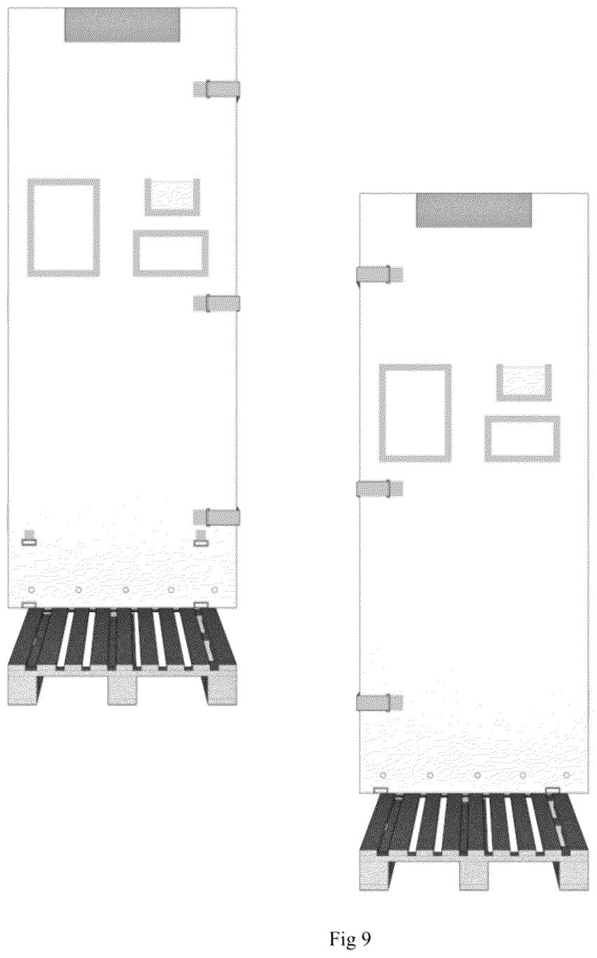

FIG. 10 shows bottom view of zipper involved in the assembly as per preferred embodiments of the invention.

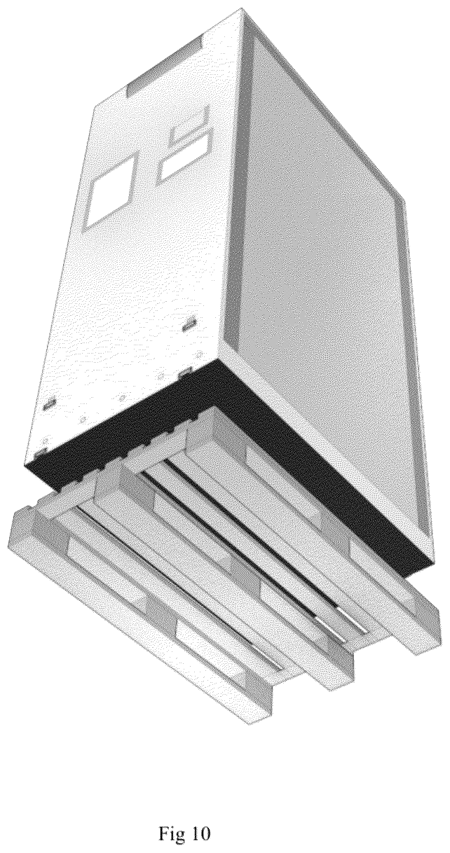

FIG. 11 shows front view of zipper involved in the assembly as per preferred embodiments of the invention.

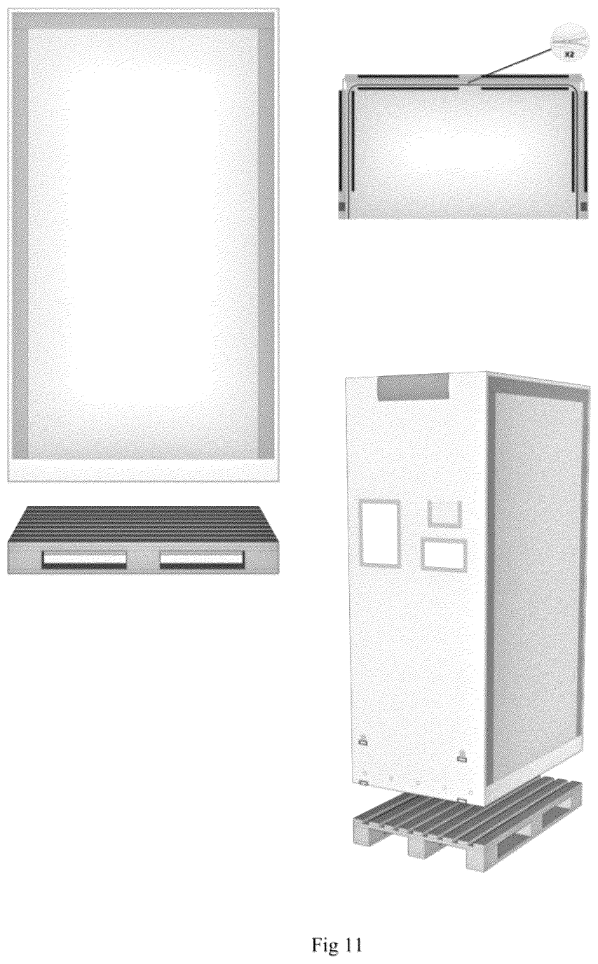

FIG. 12 shows side view of zipper involved in the assembly as per preferred embodiments of the invention.

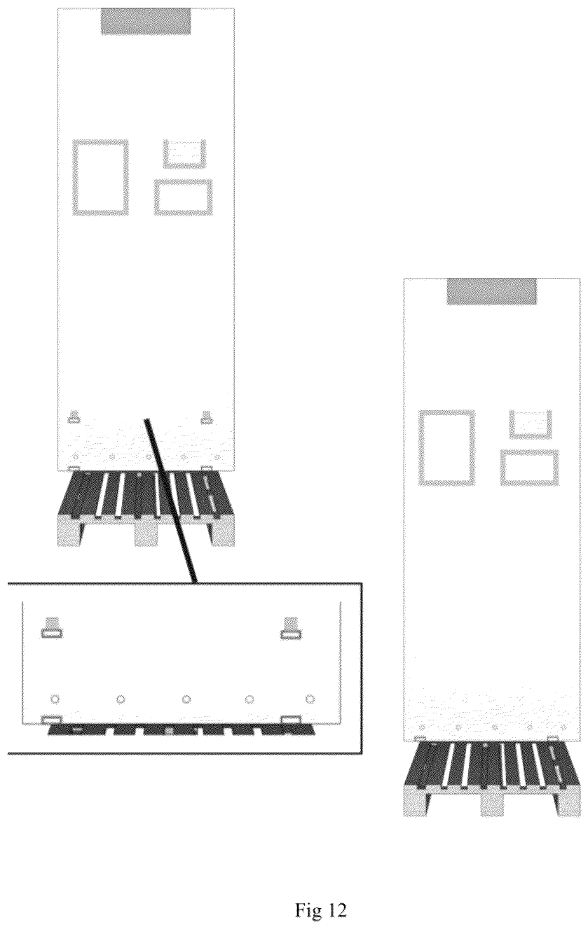

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention describes a reusable pallet tent that is used to transport goods, like (small) boxes, on different types of pallets. The said pallet tent has only one opening on the side, which is closed with two zippers from bottom to top. For use, the tent is placed on a pallet and before the goods are stacked inside the tent. When solidity for the small goods is needed, the zippers are raised a little by little to close the tent completely.

The said tent is beneficial in that it is reusable and foldable so that it can be piled up for transportation. The material used in making the said tent are solid to ensure that the tent is durable and long lasting. Further, the invention is friendly to environment in that the tent is designed to transport higher volumes of goods at the same time inside a truck. This lowers CO2 emissions as well as lower use of plastic foil to seal a pallet and lower use of cardboard boxes that need to be recycled.

The material used to snake the tent as per further embodiments includes 100% Polyester 2000D Oxford fabric, Waterproof, PU coating, PVC coating, and Reinforced stitches at all seams. The Extra UV resistant coating prevents aging and discoloration due to sunlight. Furthermore, with scratch resistant material, avoid scratching the cover surface by sharp objects. The zip, and two metal zippers allow closing the tent from bottom to top.

The tent furthermore provides protection strap with Velcro to protect the zipper. The 6 loop straps on the protection strap allows to hold the door the door when it's rolled up. The piece of Velcro on the inside of the door which is at the top of the door is used for rolling up the door on a large stick. The five rings on both sides allow for better air handling.

The document and label holders are present on both sides. The large piece of fabric, reinforced to the tent on both sides and is near to the top which is to slide the steel holder in, to keep the tent up. The 4 metal rings are attached to the bottom and used to keep the tent together when fold up. The 2 extra metal rings on one side are to hold the cord with the carabiner in place during transport. The bottom part of the tent is reinforced with Carbon fiber fabric. The Zipper tent door can also be built as a double-sided door tent.

Another variation of reusable tents is Velcro tent whose door closes by using Velcro only. The six extra straps with Velcro allow to protect the door from opening. Furthermore, for the pp straps, 3 extra metal rings will be placed on both sides of the tent. Furthermore 6 loop straps on the side of the tent and underneath the door allow to hold the door the door when it's rolled up). The additional piece of Velcro on the inside of the door is used for rolling up the door on a large stick.

The 5 rings on both sides allow for better air handling. The document and label holders are present on both sides. The large piece of fabric, reinforced to the tent on both sides and near to the top. To slide the steel holder in to keep the tent up. The four metal rings are attached to the bottom and are used to keep the tent together when fold up. The 2 extra metal rings on 1 side allows to hold the cord with the carabiner in place during transport. The bottom of the tent is reinforced with Carbon fiber fabric.

The present invention applies to portable and foldable tents that can be used on different types of pallets. The tent has advantages including being waterproof. It has a UV-resistant coating and with scratch-resistant material it is durable and long lasting. It is a transporting pallet tent, where small goods can be placed in. The tent has 2 metal zippers to close the opening from bottom to top. It is waterproof and have reinforced stitches at all seams. An extra UV-resistant coating prevents aging and discoloration due to sunlight. It has a scratch-resistant material, avoid scratching the cover surface by sharp objects. The tent has a very easy workability, the simplicity of the tent can be handled by one person. The tent doesn't have expensive materials, so it is very attractive to be used on a large scale by logistics companies. Because almost all companies around the world want to lower their CO2 emissions, there is a huge chance they will use this pallet tent to transport their goods. Easy usage, durable, non-expansive materials and a huge help in lowering the CO2 emissions

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present inventions.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A reusable pallet tent, comprising:
a. Two metal zippers,
b. Velcro,
c. 100% Polyester 2000D Oxford fabric,
d. A waterproof,
e. A PU coating,
f. A PVC coating,
g. Reinforced stitches at all seams,
h. An Extra UV-resistant coating, and
i. A scratch-resistant material.

2. The reusable pallet tent according to claim 1, wherein the tent is reusable and foldable with reinforced stitches.

3. The reusable pallet tent according to claim 2, wherein the tent has one opening on the side that is closed with two metal zippers from bottom to top.

4. The reusable pallet tent according to claim 3, wherein the metal zippers are used for closing the tent from bottom to top.

5. The reusable pallet tent according to claim 4, wherein the metal zippers are raised a little by little to close the tent completely.

6. The reusable pallet tent according to claim 1, wherein the extra UV-resistant coating to prevent aging and discoloration due to sunlight.

7. The reusable pallet tent according to claim 1, wherein the scratch-resistant material is utilized to avoid scratching the cover surface by sharp objects.

8. The reusable pallet tent according to claim 1, wherein the tent is portable and foldable and can be used on different types of pallets.

9. The reusable pallet tent according to claim 1, wherein the tent is used to transport goods, like boxes on different types of pallets.

10. The reusable pallet tent according to claim 9, wherein the tent:

11. only one opening on the side, which is closed with two zippers from bottom to top;
a. is placed an a pallet and before the goods are stacked inside the tent;
b. zippers are raised a little by little to close the tent completely to cover small goods;
c. is beneficial in that it is reusable and foldable so that it can be piled up for transportation.
d. the material used in making the said tent are solid to ensure that the tent is durable and long lasting.
e. is friendly is environmentally friendly in that it is designed to transport higher volumes of goods at the same time inside a truck, which lowers CO2 emissions as well as lower use of plastic foil to seal a pallet and lower use of cardboard boxes that need to be recycled.
